(19) United States
(12) Patent Application Publication
(10) Pub. No.: US 2022/0072631 A1
(43) Pub. Date: Mar. 10, 2022

(54) MILLING HEAD, TURN-MILL MACHINE AND METHOD

(71) Applicant: Yakov MANAS, Holon (IL)

(72) Inventor: Yakov MANAS, Holon (IL)

(21) Appl. No.: 17/423,477

(22) PCT Filed: Jan. 15, 2020
(86) PCT No.: PCT/IL2020/050070

§ 371 Date: Jul. 16, 2021

Related U.S. Application Data
(60) Provisional application No. 62/792,942, filed on Jan. 16, 2019.

(51) Int. Cl. B23C 3/02; B23C 5/22; B23C 7/02; B23C 9/00

(52) U.S. Cl. CPC B23C 3/02; B23C 5/2226; B23C 7/02; B23C 2226/31; B23C 2220/28; B23C 2226/27; B23C 9/005

(57) ABSTRACT

A milling head includes a milling head base, a plurality of blades annularly arranged around the milling head base; and an actuator to rotate the milling head base. Each of the plurality of blades extends from the base at a differential radial distance as compared to a neighboring blade from the plurality of blades.

### RELATED APPLICATION

This application claims the benefit of priority from U.S. Provisional Patent Application No. 62/792,942 filed on 16 Jan. 2019, the contents of which are incorporated herein by reference in their entirety.

### FIELD AND BACKGROUND OF THE INVENTION

The present invention, in some embodiments thereof, relates to a milling head and turn-mill and, more particularly, but not exclusively, to a milling head and turn mill suitable for machining composite materials.

Composite materials are known to be used in diverse applications. Many applications require machining of composite materials to obtain a desired structure. Mechanical behavior of such materials during machining may significantly differ from those of metals. Traditional machining operations such as drilling, sawing and milling may pose new challenges when performed on composite materials. For example, fiber reinforcement in composites may often be very abrasive and may lead to rapid tool wear of the machined surfaces. Deformation of the workpiece may occur during machining. Composite materials may also be subject to delaminations during machining that may lead to significant reduction in their load-carrying capacity and disqualification of the workpiece. Some new technologies have been developed to help overcome some of the challenges related to machining composite materials. Laser and waterjet cutting are example methods that are geared toward working with composite materials.

In the book entitled “Machining of Composite Materials, Composites Engineering Handbook”, pages 777-809 by Abrate, S. (1997), turn-milling is disclosed as a method suitable for hard-to-machine material or large work diameter. Turn-milling combines two conventional machining operations; turning and milling. It is disclosed that the intermittent nature of the process reduces forces on the workpiece, cutting temperatures and thus tool wear, and helps breaking of chips.

### SUMMARY OF THE INVENTION

According to some example embodiments, there is provided a milling head including a plurality of blades that protrudes out at differential distances. According to some example embodiments, the distance that each blade protrudes increases in the clockwise or counterclockwise direction. During operation, the plurality of blades may be configured to be rotationally aligned with the working piece so that the blade that is most recessed with respect to the milling head provides a first depth of cut and the other blades provide in a consecutive order additional depths of cut such that each blade provides an additional depth of cut as compared to the previous blade. Over one rotation of the milling head or part of a full rotation of the milling head, the overall depth of cut may be an accumulation of the depth of cuts provided by each blade. In this manner, material may be removed from the workpiece using a plurality of blades instead of only one blade and the material may be removed in a series of smaller steps or thinner layers. The gradual removal of thinner layers with a plurality of blades provides less strain, heating and deformation on the workpiece and less wear on each blade.

In some example embodiments, the milling head is part of a turn-mill machine and rotation of the milling head as well as translation in a feed direction is coordinated with rotation of the workpiece. Optionally, the milling head as described herein is configured to avoid one or more of delamination, elevation in temperature, deformation of the workpiece, and to provide a smoother finish and to reduce a frequency at which the blades need to be replaced. In some example embodiments, the milling head and/or the turn-milling are configured for machining composite material.

According to aspects of some embodiments there is provided a milling head comprising: a milling head base; a plurality of blades annularly arranged around the milling head base; and an actuator configured to rotate the milling head base; wherein each of the plurality of blades extends from the base at a differential radial distance as compared to a neighboring blade from the plurality of blades.

Optionally, the plurality of blades are symmetrically arranged around the base. Optionally, the radial distance that each of the plurality of blades protrudes from the base steadily increases in a counter clockwise direction or in a clockwise direction. Optionally, the milling head includes a sensor configured to sense an angular position of the milling head.

Optionally, the milling head includes an aligning device configured to position a selected blade from the plurality of blades in defined angular position with respect to an axis of rotation of the milling head.

Optionally, the differential radial distance between pairs of neighboring blades from the plurality of blades is 0.5-2 mm.

Optionally, the differential in radial distance that each of the plurality of blades protrudes as compared to its neighboring blade from the plurality of blades is a same differential.

Optionally, the radial distance that each of the plurality of blades protrudes from the base increases in a counter clockwise direction or in a clockwise direction and wherein a last pair of the plurality of blades has a differential in radial distance that is at least five times less that of the other pairs of neighboring blades from the plurality of blades.

Optionally, the milling head includes a plurality of blade holders extending from the annular base in a radial direction, wherein each of the plurality of blades is configured to be supported by one of the plurality of blade holders.

Optionally, each of the plurality of blade holders have a different length and wherein the different length is configured to position the plurality of blades in the differential radial distance.

Optionally, each of the plurality of blade holders includes a blade holder and wherein each of the plurality of blades is configured to be replaceably fitted the blade holder.

Optionally, the plurality of blades are diamond blade knives.

According to aspects of some embodiments there is provided a turn-mill machine comprising: a milling head according to any one of claims 1-12; and a first actuator configured to rotate the workpiece.

Optionally, an axis of rotation of the milling head is perpendicular to an axis of rotation of the workpiece.

Optionally, an axis of rotation of the milling head is parallel to an axis of rotation of the workpiece.

Optionally, the turn-mill machine includes a controller configured to control rotation of each of the milling head and the workpiece.

Optionally, the controller includes intranet of things.

Optionally, the controller is configured to coordinate rotation of the milling head with the rotation of the workpiece.

Optionally, the controller is configured to coordinate stepping of the milling head in the feed direction with the rotation of the workpiece.

Optionally, the controller is configured to control selection of a blade from the plurality of blades engaging the workpiece per rotation of the workpiece.

Optionally, the controller is configured to step the milling head with respect to the workpiece in a feed direction.

Optionally, the milling head is configured to be selectively replaced with another milling head from a group of milling heads that differ in milling head base diameter, number of blades, and differential positions of the blades in the radial direction.

According to aspects of some embodiments there is provided a method for processing a workpiece, the method comprising: selecting a rotating ratio between a milling head and a workpiece on a turn-mill machine; aligning a blade of the milling head with the workpiece, wherein the milling head includes a milling head base and a plurality of blades annularly arranged around the milling head base, and wherein each of the plurality of blades extends from the base at a differential radial distance as compared to a neighboring blade from the plurality of blades; rotating the milling head in coordination with rotating the workpiece based on the selected rotating ratio.

Optionally, the method includes advancing in a feed direction the milling head with respect to the workpiece in steps.

Optionally, the rotating ratio is selected per step in the feed direction.

Optionally, the method includes selecting a milling head from a plurality of milling heads based on milling head base diameter, number of blades, and differential positions of the blades in the radial direction.

Optionally, the method includes defining a number of rotations of the workpiece for each of the plurality of blades of the milling head engaging the workpiece.

Optionally, the blade of the milling head that is aligned with the workpiece is configured to remove a first sub-layer of material from the workpiece and each of the plurality of blades is configured to remove additional sub-layers in turn.

Optionally, one of the plurality of blades is configured to provide a smooth finish of the workpiece.

Optionally, the rotating ratio is variable along a feed direction of the turn-mill machine.

Optionally, the radial distance that each of the plurality of blades protrudes from the base steadily increases in a direction of rotation of the milling head.

Optionally, the milling head and the turn-mill machine coordinate movement based on intranet of things.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified schematic drawing of an example milling head of a turn-milling machine in accordance with some example embodiments;

FIGS. 2A, 2B and 2C are example perspective, side and bottom views of a milling head in accordance with some example embodiments;

FIGS. 3A and 3B are simplified schematic drawings of example orthogonal milling head and coaxial milling head respectively in accordance with some example e embodiments; and

FIG. 4 is a simplified flow chart of an example method for turn-milling in accordance with some example embodiments.

### DESCRIPTION OF SPECIFIC EMBODIMENTS OF THE INVENTION

The present invention, in some embodiments thereof, relates to a milling head and turn-mill and, more particularly, but not exclusively, to a milling head and turn mill suitable for machining composite materials.

According to some example embodiments, a milling head includes a plurality of blades annularly positioned around a base of a milling head. Optionally, the blades may be angled with respect to the base of the milling head. According to some example embodiments, the blades are configured to protrude radially, each at a differential radial distance. Protrusion of the blades may be configured to steadly increase in one of a clockwise or counterclockwise direction. The differential radial distances may be achieved with different size blades or based on blade holders or blade holder holders that are configured to extend each blade to a differential radial distance. In some example embodiments, the differential radial distance between neighboring blades may be 0.1-3.0 mm or 1-2 mm.

In some example embodiments, the differential radial distance may be adjusted for a particular material being machined. For example, a smaller differential radial distance may be selected for material that is more brittle or more easily subject to deformation. In some example embodiments, different milling heads may provide different radial distances. Optionally, when the differential radial distance is set by the blade holder, the blade holder may include an adjusting mechanism, e.g. an adjusting screw based on which the differential radial distances may be set. In other example embodiments, the blade holders may be replaceable and may be selected based on the desired differential radial distance.

In some example embodiments, the milling head includes an aligning device configured to align the blade that is most recessed with respect to the base of the milling head with the workpiece. The aligning device may include for example a sensor, e.g. optical sensor configured to provide indication when proper alignment is met or other sensor configured to define angular position of the milling head. Optionally, the aligning device may include a magnetic device configured to align the blade of the milling head to the workpiece. Optionally, intranet of things may be applied to establish communication between the milling head and a device holding the workpiece based on which aligning may be performed. In some example embodiments, the aligning device may be at least partially integrated on a portion of the turn-milling machine that is configured to hold the workpiece. Optionally, the aligning device may be included in the milling head. According to some example embodiments, the milling head is configured to advance in a feed direction in steps and a speed of the milling head may be coordinated with a speed of the workpiece to obtain a desired processing of the workpiece. In some example embodiments, the number of rotations of the workpiece per blade in the milling head and per position in the feed direction is selected to provide a desired result.

In some example embodiments, the milling head includes 2-8 blades, e.g. 6 blades. In other example, the milling head may include 10-40 blades or more depending on size of milling head. Optionally, the blades are diamond blade knives. Optionally, the blades are configured to machine composite material, hard to machine material, e.g. brittle material.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

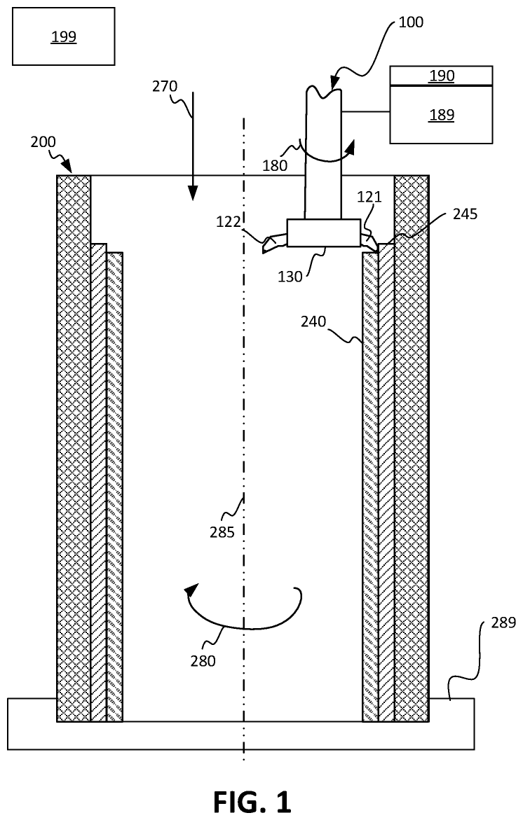

Referring now to the drawings, FIG. 1 is a simplified schematic drawing of an example milling head of a turn-mill machine in accordance with some example embodiments. In some example embodiments, a turn-mill machine is configured to rotate a workpiece 200 in a direction 280 while a milling head 100 is configured to remove material from a surface of workpiece 200. Milling head may be rotated in a direction 180 opposite that of direction 280. In some example embodiments, milling head includes at least a first blade 121 and a second blade 122. Optionally, first blade is configured to remove a portion of sub-layer 240 and second blade 122 is configured in turn to remove a portion of sub-layer 245 that has been exposed by first blade 121. Second blade 122 is further extended in a radial direction as compared to first blade 121 and therefore may remove sub-layer 245. Each of first blade 121 and second blade 122 may be configured to provide a depth of cut in an order of magnitude of 1 mm and together the first blade 121 and second blade 122 may provide a depth of cut equaling the depth of cut of first blade 121 plus the depth of cut of second blade 122, e.g. 2 mm. Optionally, the depth of cut provided by each of the blades is not be the same. In some example embodiments, one of the blades may be configured for providing a smooth finish and may provide a significantly smaller depth of cut as compared to the other blades, e.g. a depth of cut of between 0.05 to 0.5 mm. Optionally, the at least one sub-layer with thickness of between 0.05 to 0.5 mm may be the last sub-layer removed.

Thickness of the sub-layers may change based on application, e.g. based on a type of material that is being machined and/or size of cut required. Once both first sub-layer 240 and second sub-layer 245 is removed at one position along a feed direction 270, milling head 100 may be advanced with respect to workpiece 200 in feed direction 270 to continue removing both first sub-layer 240 and second sub-layer 245 at next position along the feed direction 270. Milling head 100 may move with respect to workpiece 200 in pulses or steps.

According to some example embodiments, a controller 199 is configured to control one or more actuators 189 configured for rotating and translating milling head 100 and is also configured to control one or more actuators 289 configured to control rotation of the workpiece and optionally translation of the workpiece in feed direction. Optionally, one or more actuators 189 rotate milling head in direction 180 and translate milling head both in direction 270 and in a direction toward and away from workpiece 200, e.g. perpendicular to direction 270. In this example, feed direction 270 is parallel to rotational axis 285. However, in other cases based on the shape of the workpiece, the feed direction may be angled with respect to rotational axis 285.

According to some example embodiments, controller 199 is configured to control coordination between rotation of milling head 100 in direction 180, rotation of workpiece 200 in direction 280 and advancement of milling head 100 in feed direction 270. In some example embodiments, a rotation ratio is defined and provided as input to controller 199. The rotation ratio is defined herein as rotational speed of milling head 100 in direction 180 over rotational speed of workpiece 200 in direction 280. Optionally, the rotation ratio may be variably defined over the feed direction 270. For example, the number of rotations of workpiece 200 that each of blade 121 and blade 122 sees may be defined at each step displacement along feed direction 270.

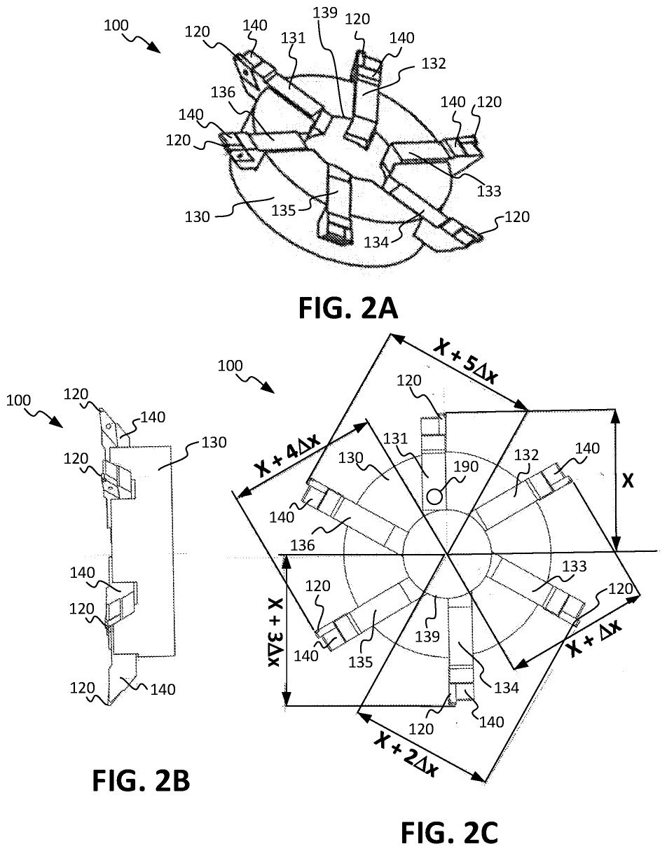

Reference is now made to FIGS. 2A, 2B and 2C showing example perspective, side and bottom views of a milling head in accordance with some example embodiments. According to some example embodiments, milling head 100 includes a plurality of blades 120 that are annularly arranged around a base 130. In some example embodiments, an array of blade holders 131, 132, 133, 134, 135 and 136 extend from an inner surface 139 of milling head 100 and protrude out in a radial direction. Each of blade holders 131, 132, 133, 134, 135 and 136 may be fixedly attached or integrated as part of base 130 of milling head 100. Blades 120 may be replaceably connected to milling head 100 with blade holders 140. For example, each of blade holders 131, 132, 133, 134, 135 and 136 may include a blade holder 140 that holds a blade 120. According to some example embodiments, blade holders 131, 132, 133, 134, 135 and 136 are of different lengths and the different lengths are defined to increase in a clockwise or counterclockwise direction. For example blade holder 131 may support blade 120 at radial position X, blade holder 132 may support blade 120 to radial position X+Δx, blade holder 133 may support blade 120 at radial position X+2Δx, blade holder 134 may support blade 120 at radial position X+3Δx, blade holder 135 may support blade 120 at a radial position X+4Δx and blade holder 136 may support blade 120 at a radial position X+5Δx. In some example embodiments, Δx may be between 0.2-3 mm, e.g. 1 mm. In some example embodiments, the last blade (in blade holder 136) in the array may be configured to provide a smooth finish to the workpiece.

Optionally, a differential length between blade holder 136 and blade holder 135 may only be 0.1 mm or 0.03-0.7 mm. For example blade holder 131 may support blade 120 at radial position X, blade holder 132 may support blade 120 to radial position X+Δx, blade holder 133 may support blade 120 at radial position X+2Δx, blade holder 134 may support blade 120 at radial position X+3Δx, blade holder 135 may support blade 120 at a radial position X+4Δx and blade holder 136 may support blade 120 at a radial position X+4Δx+Δy. Δy may be defined to be 5 to 15 times smaller than Δx. In some example embodiments, the blade providing the finish may be repeatedly applied on the surface of the workpiece to get a smoother finish (over more than one rotation of workpiece 200). Optionally, the finish may be provided by more than one blade, e.g. the blades in blade holder 135 and 136. The differential length between the blades may be selected to be small when the blade is designated for providing a finish, e.g. a smooth finish as described herein.

Optionally, some or all of blades 120 are diamond blade knives and may be configured for cutting hard and/or brittle material such as composite materials. Optionally, a variety of blades may be mounted on milling head 100, e.g. the blade providing a finish may have different properties as compared to the other blades on milling head 100. According to some example embodiments, as milling head 100 is rotated, the array of knives are configured to remove material, e.g. each at a depth of cut of Δx or at variable depths of cuts. Milling head 100 may be maintained in a same position over a full rotation so that the accumulated depth of cut reached may be 6Δx for the six blades 120 or when the last blade is applied to provide a finish the depth of cut reached may be 5Δx+Δy where Δy is significantly smaller than Δx. This depth of cut is accomplished in a consecutive manner with each blade 120 removing material at a depth of cut of Δx, followed by another blade extended further than the previous blade that also removes material at a depth of cut of Δx. Optionally, the last blade in the succession may buff the surface of the workpiece.

In some example embodiments, milling head 100 includes an aligning mechanism 190 (FIG. 1) that is configured to be used to align the first blade 131 with the workpiece at the start of the machining operation. Optionally, intranet of things may be applied to communicate orientation between first blade 131 and workpiece.

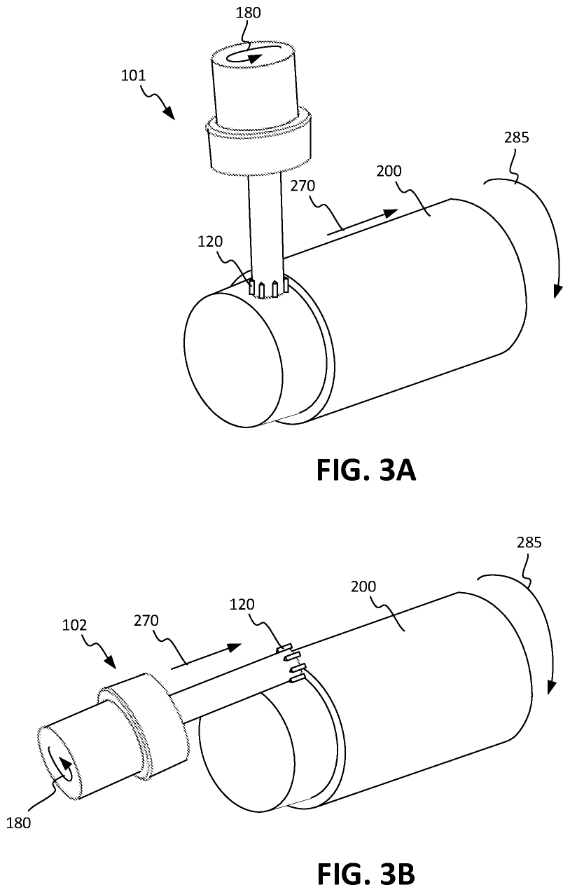

Reference is now made to FIGS. 3A and 3B showing simplified schematic drawings of example orthogonal milling head and coaxial milling head respectively in accordance with some example embodiments. According to some example embodiments, milling head may be part of a turn-mill machine. In some example embodiments, the turn-mill machine may be an orthogonal turn-mill machine such that a rotation axis of its milling head 101 is perpendicular to a rotation axis of workpiece 200 (FIG. 3A). In other example embodiments, the turn-mill machine may be and a co-axial turn-mill machine such that a rotation axis of its milling head 101 and a rotation axis of the workpiece 200 are parallel to each other (FIG. 3B).

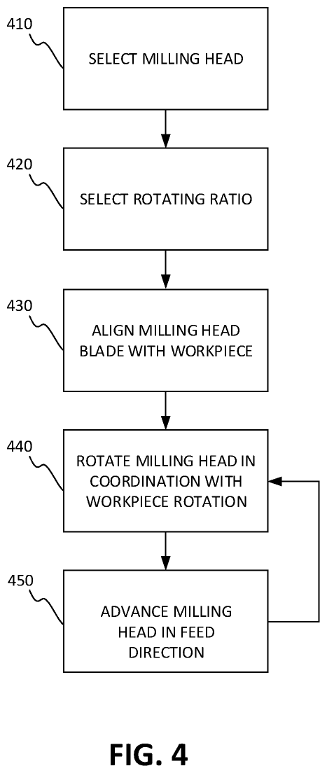

Reference is now made to FIG. 4 showing a simplified flow chart of an example method for turn-milling in accordance with some example embodiments. According to some example embodiments, a milling head is selected based on one or more of the dimensions of the workpiece, the geometry of a desired cut and the material properties of the workpiece (block 410). The different milling heads may differ in one or more of diameter of its base, number of blade holders, and differential positions of the blades in the radial direction. Optionally, different types of blades may be selectively mounted on the milling head based on a desired output. According to some example embodiments, based on the milling head selected, a rotating ratio may be selected (block 420). The rotation ratio may be variable along the feed direction and may be defined over the entire feed direction or part of the feed direction. The rotation ratio may also be defined per blade. For example, one blade in the milling head may be defined to engage the workpiece over a full rotation of the workpiece while a second blade in the milling head may be defined to engage the workpiece over a plurality of rotations. Optionally, the last blade in the array, e.g. the blade that protrudes the furthest and/or that provides the finish may be defined to engage the workpiece over one or more rotations to achieve a smoother finish.

According to some example embodiments, milling head is aligned with the workpiece so that the blade that is most recessed with respect to the workpiece is aligned with the workpiece at the start of the operation (block 430). The rotation of the milling head is defined such that after the most recessed blade engages the workpiece, the next blade to engage the workpiece is the blade that is the second most recessed with respect to the workpiece. A milling head motor or actuator may spin the milling head in a desired direction and at a defined speed (block 440). Milling head may also be advanced in a feed direction (block 450). According to some example embodiments, advancement in the feed direction occurs in a step after each defined rotation of the milling head, e.g. partial rotation, full rotation or a plurality of rotations (block 430). Material may then be removed in the new position along the feed direction (block 420). This process may be repeated until the material removing is completed. Optionally, some blades may be selected to be idle or some blades may not be positioned in one or more of blade holders when not needed for a particular machining process. In some example embodiments, a first group of blades in the milling head are selected to machine a first part of the workpiece while a second group of blades in the milling head are selected to machine a second part of the work piece. Optionally, there is some overlap between the first group and second group of blades.

In this manner, the machining may be performed with fewer intermissions that may otherwise be needed to machine the workpiece.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. In addition, any priority document(s) of this application is/are hereby incorporated herein by reference in its/their entirety.

1. A milling head comprising:
a milling head base;
a plurality of blades annularly arranged in a plane around the milling head base; and
an actuator configured to rotate the milling head base;
wherein each of the plurality of blades extends from the base at a differential radial distance as compared to a neighboring blade from the plurality of blades.

2. The milling head of claim 1, wherein the plurality of blades are symmetrically arranged around the base.

3. The milling head of claim 1, wherein the radial distance that each of the plurality of blades protrudes from the base steadily increases in a counter clockwise direction or in a clockwise direction.

4. The milling head of claim 1 comprising a sensor configured to sense an angular position of the milling head.

5. The milling head of claim 4, comprising an aligning device configured to position a selected blade from the plurality of blades in defined angular position with respect to an axis of rotation of the milling head.

6. The milling head of claim 1, wherein the differential radial distance between pairs of neighboring blades from the plurality of blades is 0.5-2 mm.

7. The milling head of claim 1, wherein the differential in radial distance that each of the plurality of blades protrudes as compared to its neighboring blade from the plurality of blades is a same differential.

8. The milling head of claim 1, wherein the radial distance that each of the plurality of blades protrudes from the base increases in a counter clockwise direction or in a clockwise direction and wherein a last pair of the plurality of blades has a differential in radial distance that is at least five times less that of the other pairs of neighboring blades from the plurality of blades.

9. The milling head of claim 1, comprising a plurality of blade holders extending from the milling head base in a radial direction, wherein each of the plurality of blades is configured to be supported by one of the plurality of blade holders.

10. The milling head of claim 9, wherein each of the plurality of blade holders have a different length and wherein the different length is configured to position the plurality of blades in the differential radial distance.

11. The milling head of claim 9, wherein each of the plurality of blade holders includes a blade holder and wherein each of the plurality of blades is configured to be replaceably fitted with the blade holder.

12. The milling head according to claim 1, wherein the plurality of blades are diamond blade knives.

13. A turn-mill machine comprising:
a milling head comprising:
a milling head base;
a plurality of blades annularly arranged in a plane around the milling head base; and
an actuator configured to rotate the milling head base, wherein each of the plurality of blades extends from the base at a differential radial distance as compared to a neighboring blade from the plurality of blades; and
a first actuator configured to rotate the workpiece.

14. The turn-mill machine of claim 13, wherein an axis of rotation of the milling head is perpendicular to an axis of rotation of the workpiece.

15. The turn-mill machine of claim 13, wherein an axis of rotation of the milling head is parallel to an axis of rotation of the workpiece.

16. The turn-mill machine of claim 13, comprising a controller configured to control rotation of each of the milling head and the workpiece.

17. The turn-mill machine of claim 16, wherein the controller includes intranet of things.

18. The turn-mill machine of claim 16, wherein the controller is configured to coordinate rotation of the milling head with the rotation of the workpiece.

19. The turn-mill machine of claim 16, wherein the controller is configured to coordinate stepping of the milling head in the feed direction with the rotation of the workpiece.

20. The turn-mill machine of claim 17, wherein the controller is configured to control selection of a blade from the plurality of blades engaging the workpiece per rotation of the workpiece.

21. The turn-mill machine of claim 16, wherein the controller is configured to step the milling head with respect to the workpiece in a feed direction.

22. The turn-mill machine according to claim 13, wherein the milling head is configured to be selectively replaced with another milling head from a group of milling heads that differ in milling head base diameter, number of blades, and differential positions of the blades in the radial direction.

23. A method for processing a workpiece, the method comprising:
selecting a rotating ratio between a milling head and a workpiece on a turn-mill machine;
aligning a blade from a plurality of blades of the milling head with the workpiece, wherein the milling head includes a milling head base and the plurality of blades annularly arranged in a plane around the milling head base, and wherein each of the plurality of blades extends from the base at a differential radial distance as compared to a neighboring blade from the plurality of blades;
rotating the milling head in coordination with rotating the workpiece based on the selected rotating ratio.

24. The method of claim 23, comprising advancing in a feed direction the milling head with respect to the workpiece in steps.

25. The method of claim 24, wherein the rotating ratio is selected per step in the feed direction.

26. The method of claim 23, comprising selecting a milling head from a plurality of milling heads based on milling head base diameter, number of blades, and differential positions of the blades in the radial direction.

27. The method of claim 23 comprising defining a number of rotations of the workpiece for each of the plurality of blades of the milling head engaging the workpiece.

28. The method of claim 23, wherein the blade of the milling head that is aligned with the workpiece is configured to remove a first sub-layer of material from the workpiece and each of the plurality of blades is configured to remove additional sub-layers in turn.

29. The method of claim 23, wherein one of the plurality of blades is configured to provide a smooth finish of the workpiece.

30. The method of claim 23, wherein the rotating ratio is variable along a feed direction of the turn-mill machine, or wherein the radial distance that each of the plurality of blades protrudes from the base steadily increases in a direction of rotation of the milling head, or wherein the milling head and the turn-mill machine coordinate movement based on intranet of things.

31-32. (canceled)
